(19) United States
(12) Patent Application Publication
(10) Pub. No.: US 2010/0306751 A1
(43) Pub. Date: Dec. 2, 2010

(54) EXECUTION RESULT CACHING AND SEARCHING

(76) Inventor: James Paul Schneider, Raleigh, NC (US)

Correspondence Address: RED HAT/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/474,219

(22) Filed: May 28, 2009

(51) Int. Cl. G06F 9/45

(52) U.S. Cl. 717/143

(57) ABSTRACT

An apparatus and a method for searching and caching results of pure functions in a computer program is described. The computer program is parsed to identify pure functions. A computed result of the identified pure functions is stored and shared with at least one process of the computer program. Each identified pure functions is replaced with the computed result of the corresponding pure function.

### TECHNICAL FIELD

Embodiments of the present invention relate to computing systems, and more particularly, to computer programs.

### BACKGROUND

A typical computer program contains many instances of what are known as “pure functions”. These are functions that produce deterministic results based exclusively on their input, with no side effects. For example, the arithmetic expression “a+b” is a pure function because it only depends on the values of a and b, and does not have any state-changing side effects.

Several functions that are not traditionally thought of as “pure” functions can be recast as pure, if the correct view of their arguments is selected. For example, the C function strlen(s) returns the length of the character string pointed to by the character pointer s. Since the data stored at the location pointed to by s can be changed, strlen is not normally considered to be pure because it may give different results for the same value of s at different times. However, if the contents of what a pointer points to and not the pointer itself is considered, a string with the same representation will always produce the same result. Thus, the challenge becomes efficiently determining the identity of the argument. Generally speaking, operations to determine the identity of the string are at least as expensive as searching for the terminator to the string. So in most cases, the strlen(s) function just looks for the string terminator, and its status as a “pseudo-pure” function is nothing more than a curiosity.

The composition of a succession of pure functions is itself a pure function. Further, a function that is not pure may be considered pure if it has no side effects that extend beyond the operation of the function itself (or, put it another way, if state changes only take place within the scope of the function itself).

As a concrete example, consider the C qsort( ) function—this function does an inplace sort of a region of memory based on criteria embodied within a callback function that provides ordering information. Given a particular memory region content, and a particular ordering function, if the ordering function is pure, this (potentially very time consuming) function can be considered pure. In other words, if the contents of the region of memory described by the arguments to the qsort function matches the contents of a region of memory that was previously processed by the qsort function, and the ordering function used in both cases is identical and pure, the second operation of the qsort function can be replaced by a direct substitution of the results obtained in the first case.

For the qsort case in particular, this is a bigger “win” than might at first be apparent, since the qsort function is recursive—a region that doesn't exactly match a previous invocation of qsort may never the less have several smaller regions that match earlier recursive calls to qsort.

While qsort may seem to be an extreme example, there are several other time-consuming operations that could benefit from the identification of pure functions, and replacement of results by those that are previously computed.

This leads to two problems—identification of pure functions, and storing previously computed results so that they can be reused. There is considerable research in compiler design on detecting situations where some sequence of operations can be replaced by a simpler, faster, or more compact sequence (for example, a compiler may replace the expression “a=b*9” with “a=(b<<3)÷b”—replacing a multiplication by a constant with a shift and an addition). However, these techniques describe replacing generated code with equivalent generated code that satisfies some optimization constraint(s).

### BRIEF DESCRIPTION OF THE DRAWINGS

The present invention is illustrated by way of example, and not by way of limitation, in the figures of the accompanying drawings and in which:

FIG. 1 is a block diagram illustrating one embodiment of a system for identifying and replacing pure functions in a computer program.

FIG. 2 is a block diagram illustrating one embodiment of a pure function identifier. FIG. 3 is a block diagram illustrating one embodiment of a pure function identifier.

FIG. 4 is a block diagram illustrating another embodiment of a pure function identifier.

FIG. 5 is a flow diagram illustrating one embodiment of a method for identifying and replacing pure functions in a computer program.

FIG. 6 is a flow diagram illustrating another embodiment of a method for identifying and replacing pure functions in a source code version of a computer program.

FIG. 7 is a flow diagram illustrating one embodiment of a method for identifying and replacing pure functions in a compiled version of a computer program.

FIG. 8 is a flow diagram illustrating another embodiment of a method for identifying and replacing pure functions in a compiled version of a computer program.

FIG. 9 is a block diagram illustrating an example of a computer system.

### DETAILED DESCRIPTION

Described herein is a method and apparatus for searching and caching results of pure functions in a computer program. In one embodiment, the computer program is parsed to identify pure functions. A computed result of the identified pure functions is stored and shared with at least one process of the computer program. Each identified pure functions is replaced with a computed result of the corresponding pure function.

In computer programming, a function may be described as pure if: (1) the function always evaluates the same result value given the same argument value(s); the function result value cannot depend on any hidden information or state that may change as program execution proceeds, nor can it depend on any external input from I/O devices; and (2) evaluation of the result does not cause any semantically observable side effect or output, such as mutation of mutable objects or output to I/O devices.

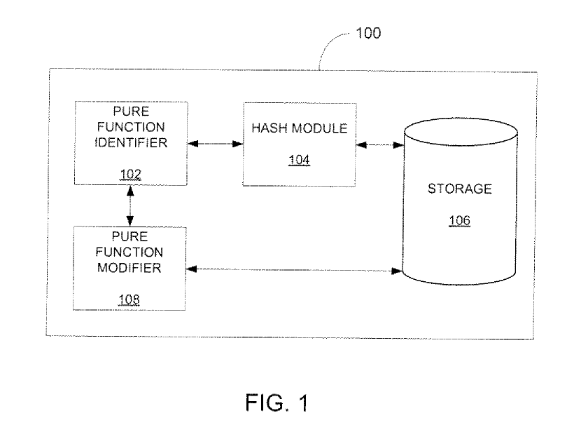

FIG. 1 is a block diagram illustrating one embodiment of a system 100 for identifying and replacing pure functions in a computer program. System 100 includes a pure function identifier 102, an optional hash module 104, a storage module 106, and a pure function modifier 108.

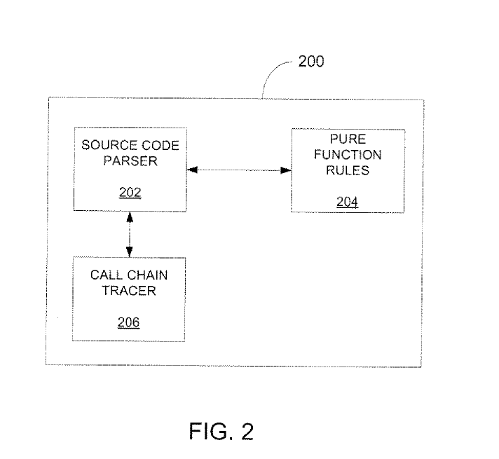

The pure function identifier 102 is configured to identify pure functions in a computer program. The computer program may be in the form of a source code or a compiled version. Various embodiments of pure function identifier 102 are further described in more detail with respect to FIGS. 2, 3, and 4.

Hash module 104 operates on the identified functions and stores the results in storage 106. In one embodiment, the parameters to the pure function would be represented in a canonical way (for example, in the order given in the function declaration, with the binary representation of each parameter considered to be concatenated to its predecessor in the list), which is hashed by one or more “fast” hash functions, and a cryptographically strong hash function. The “fast” hash function result(s) is used to index a hash table that stores the cryptographically strong hash result and a reference to the results corresponding to this particular invocation. The hash table and hash results may be stored in storage 106. In an alternative embodiment, a collection of short hashes (e.g. the concatenated values of the Jenkins “one at a time” hash, the Fowler-Noll-Vo hash implemented in 32 bits with a given basis, and MurmurHash64, for a total of 128 bits) can be used.

In one embodiment, the hash table could store only the most recent result (making this a true “cache” situation—newer results can evict older results). In another embodiment, the hash table could reference a list or tree of results. In yet another embodiment, a hybrid caching system could have the hash table store the most recent result in main memory, and have a pointer to older results stored in secondary storage (such as a filename and block offset). The hybrid caching system would be particularly useful for a program with a large working set that is executed frequently (for example, a system's sort utility). Successive executions may be able to take advantage of work that was already accomplished.

Pure function modifier module 108 is configured to take advantage of the already computed results of previously identified pure functions by replacing pure function calls with previously computed results. In one embodiment, the results of the analysis for a precompiled program could be used by a customized loader to add the code necessary to take advantage of this information to replace pure function calls with previously computed results. An alternative would be to use this as part of a virtualization layer. Advantages to the virtualization approach are that it adds the functionality to take advantage of precomputed results with minimal changes to the running code, and the purity analysis outlined in the previous paragraph could be done dynamically.

By using the previously computed results, execution of computer program is therefore improved. As such, the computation of data (video, audio, or other types of data) is improved. As a result of identifying pure functions in a computer program and using the already computed values, processing time is saved allowing a computer program to execute at a faster pace. For example, if the computer program is related to audio manipulation or processing, a user will be able to hear the audio sooner. If the computer program is related to video manipulation or processing, a user will be able to see the graphics or video sooner. The present process can also be used to improve the frame rates for video games.

FIG. 2 is a block diagram illustrating one embodiment of a pure function identifier 200 to identify pure function in a source code of a computer program. Pure function identifier 200 includes a source code parser module 202, a pure function rules module 204, and a call chain tracer module 206. Source code parser module 202 includes a compiler that finds pure functions by using rules stored in pure function rules module 204 that tell the compiler which operations are “pure”, and other rules that tell the compiler when it can consider a function that may not look pure to be “pure”. Separate compilation can be accomplished by marking functions that are pure, with the possible exception of functions they call themselves, in the compiler's results. Call chain tracer module 206 makes the ultimate determination about the purity of a function by tracing the call chain down from functions marked “pure, with possible call-related exceptions” into the functions they themselves call.

In another embodiment, the above process extends to object-oriented programming languages, too; if the result of a method depends only on the state of the object on which the method is called, plus the value of any provided arguments, and its results are confined to the state of the object itself and its return value, it can be considered “pure” in this case (although the replacement of the method call will need to include updating the calling object's state).

FIG. 3 is a block diagram illustrating one embodiment of a pure function identifier 300 for a compiled version of a computer program. Pure function identifier 300 includes a compiled code block identifier module 302, and a pure function code block parser module 304. Compiled code block identifier identifies blocks of code that make up common “pure” functions. Pure function code block parser module 304 searches for these blocks in the compiled program.

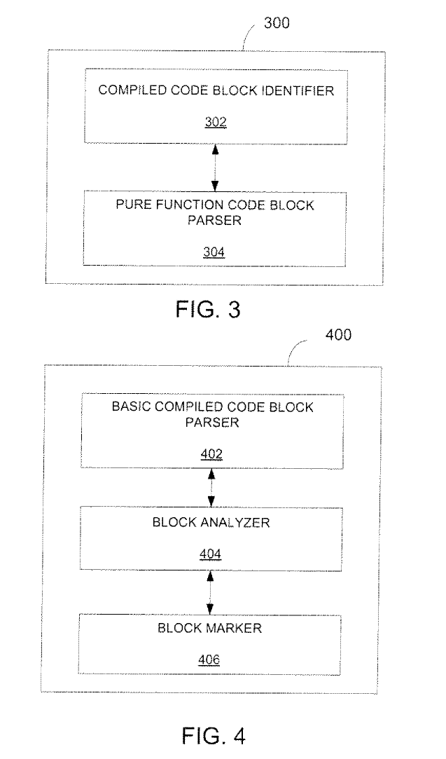

FIG. 4 is a block diagram illustrating another embodiment of a pure function identifier 400 for a compiled version of a computer program. Pure function identifier 400 includes a basic compiled code block parser module 402, a block analyzer module 404, and a block marker 406.

Basic compiled code block parser 402 examines the computer program for its basic block structure. Block analyzer module 404 examines each block to determines whether it is a pure function by examining the blocks for instructions that violate purity constraints (such as calling a system call not otherwise marked as pure, or reading from or writing to memory regions not accessed through a parameter in the scope of the block). The bulk of this analysis can be done statically for the majority of programs (self-modifying programs, or those that do run-time dynamic linking, would be obvious exceptions). Note that the analysis of a particular functional block is itself a pure function. Block marker module 406 marks each block as “pure”, “not pure”, or “pure, given called functions are pure” based on the analysis of block analyzer 404.

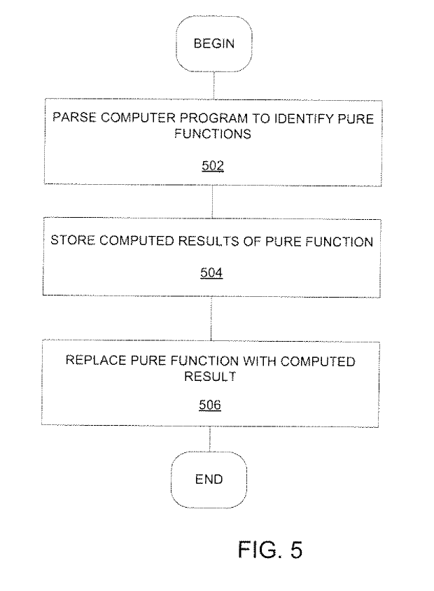

FIG. 5 is a flow diagram illustrating one embodiment of a method for identifying and replacing pure functions in a computer program. At 502, the computer program is parsed to identify pure function calls with pure function identifier 102. In one embodiment, pure function identifier 102 parses the computer program to identify pure functions based on a predetermined rule defining which function is a pure function. At 504, computed results of the computer program are stored in storage 106 to be shared with at least one process. For example, two different processes can share the computed results. At 506, pure functions in the computer program are replaced with the stored computed results. In one embodiment, pure function modifier module 108 replaces the pure functions the stored computed results.

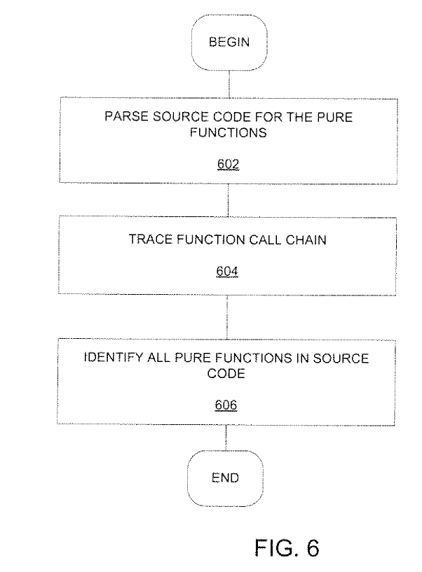

FIG. 6 is a flow diagram illustrating another embodiment of a method for identifying and replacing pure functions in a source code version of a computer program. At 602, a source code of the computer program is parsed to identify pure functions. For example, source code parser 202 parses the source code of the computer program. At 604, a function call chain is traced with call chain tracer 206 from functions marked as pure but with possible call-related exceptions to the functions called. In one embodiment, the source code of the computer program includes an object-oriented language. At 606, pure functions are identified in the source code 606.

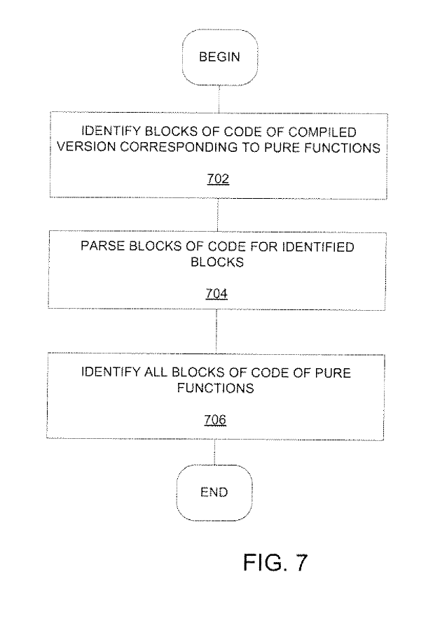

FIG. 7 is a flow diagram illustrating one embodiment of a method for identifying and replacing pure functions in a compiled version of a computer program. At 702, blocks of code of a compiled version of the computer program that correspond to pure functions are identified. In one embodiment, compiled code block identifier 302 identifies blocks of code that correspond to pure functions. At 704, the identified blocks in the compiled version are parsed. For example, pure function code block parser 304 may be used to parsed the identified blocks in the compiled version. At 706, all blocks of code associated with pure functions are identified.

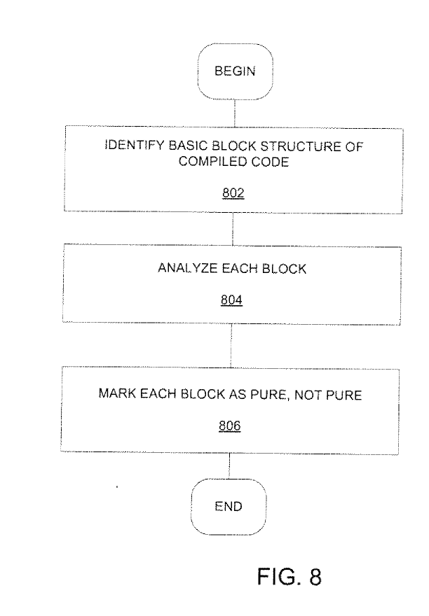

FIG. 8 is a flow diagram illustrating another embodiment of a method for identifying and replacing pure functions in a compiled version of a computer program. A compiled version of the computer program is parsed to determine a basic block structure. At 804, each blocks is examined for instructions that violate predefined purity constraints. At 806, each block is marked as pure, not pure, or pure given called functions are pure, based on the examination of each block.

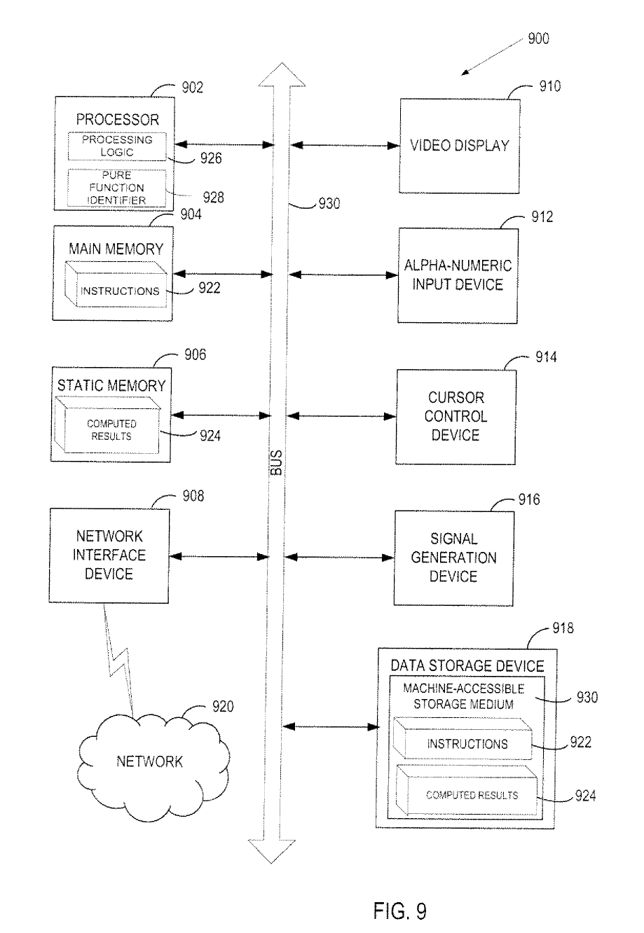

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processing device 902, a main memory 904 (e.g., read-only memory (ROM), flash memory, dynamic random access memory (DRAM) such as synchronous DRAM (SDRAM), a static memory 906 (e.g., flash memory, static random access memory (SRAM), etc.), and a data storage device 918, which communicate with each other via a bus 930.

Processing device 902 represents one or more general-purpose processing devices such as a microprocessor, central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 is configured to execute modules 926 (previously described with respect to FIG. 1) for performing the operations and steps discussed herein with. In one embodiment, the modules may be include hardware or software or a combination of both. In another embodiment, processing device 902 includes a pure function identifier module 928.

The computer system 900 may further include a network interface device 908. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

The data storage device 918 may include a computer-accessible storage medium 930 on which is stored one or more sets of instructions (e.g., software 922) embodying any one or more of the methodologies or functions described herein. The software 922 may also reside, completely or at least partially, within the main memory 904 and/or within the processing device 902 during execution thereof by the computer system 900, the main memory 904 and the processing device 902 also constituting computer-accessible storage media. The software 922 may further be transmitted or received over a network 920 via the network interface device 908.

The computer-accessible storage medium 930 may also be used to store computed results 924 of pure function identifier module 928 as presently described. Computed results may also be stored in other sections of computer system 900, such as static memory 906.

While the computer-accessible storage medium 930 is shown in an exemplary embodiment to be a single medium, the term “computer-accessible storage medium” should be taken to include a single medium or multiple media (e.g., a centralized or distributed database, and/or associated caches and servers) that store the one or more sets of instructions. The term “computer-accessible storage medium” shall also be taken to include any medium that is capable of storing, encoding or carrying a set of instructions for execution by the machine and that cause the machine to perform any one or more of the methodologies of the present invention. The term “computer-accessible storage medium” shall accordingly be taken to include, but not be limited to, solid-state memories, optical and magnetic media.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within, the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
parsing a computer program to identify a plurality of pure functions using a pure function identifier of a computer system;
storing a computed result of one of the pure functions to be shared with at least one process of the computer program in a storage device of the computer system, the storage device coupled to the pure function identifier; and
replacing an invocation of at least one pure function with the computed result of the corresponding pure function using a pure function modifier of the computer system to accelerate an execution of the computer program at the computer system, the pure function modifier coupled to the storage device.

2. The computer-implemented method of claim 1 wherein parsing further comprises:
parsing a source code of the computer program to identify the plurality of pure functions based on a predetermined rule, the predetermined rule defining which function is a pure function.

3. The computer-implemented method of claim 2 further comprising:
tracing a function call chain from functions marked as pure but with possible call-related exceptions to the functions called.

4. The computer-implemented method of claim 2 wherein the source code of the computer program includes an object-oriented language.

5. The computer-implemented method of claim 1 wherein parsing further comprises:
identifying blocks of code of a compiled version of the computer program that correspond to pure functions; and
parsing for the identified blocks in the compiled version.

6. The computer-implemented method of claim 1 wherein parsing further comprises:
parsing a compiled version of the computer program to determine a basic block structure;
examining each blocks for instructions that violate predefined purity constraints; and
marking each block as pure, not pure, or pure given called functions are pure, based on the examination of each block.

7. The computer-implemented method of claim 1 wherein parsing is performed with a virtualization layer machine, the identification of pure functions dynamically determined.

8. The computer-implemented method of claim 1 wherein storing the computed result further comprises:
computing a first hash and a second hash of the parameters of a pure function,
wherein the first hash is used to index a hash table that stored the second hash result and a reference to the results corresponding to an invocation of the hash.

9. The computer-implemented method of claim 8 wherein the hash table is configured to store the most recent results or reference a list or tree of results.

10. The computer-implemented method of claim 8 wherein the hash table is configured to store the most recent result in a primary storage, and to configure a pointer to older results stored in a secondary storage.

11. A computer-readable storage medium, having instructions stored therein, which when executed, cause a computer system to perform a method comprising:
parsing a computer program to identify a plurality of pure functions;
storing a computed result of one of the pure functions for at least one process of the computer program; and
replacing an invocation of at least one pure function with the computed result of the corresponding pure function.

12. The computer-implemented method of claim 1 wherein parsing further comprises:
parsing a source code of the computer program to identify the plurality of pure functions based on a predetermined rule, the predetermined rule defining which function is a pure function.

13. The computer-implemented method of claim 2 further comprising:
tracing a function call chain from functions marked as pure but with possible call-related exceptions to the functions called.

14. The computer-implemented method of claim 2 wherein the source code of the computer program includes an object-oriented language.

15. The computer-implemented method of claim 1 wherein parsing further comprises:
identifying blocks of code of a compiled version of the computer program that correspond to pure functions; and
parsing for the identified blocks in the compiled version.

16. The computer-implemented method of claim 1 wherein parsing further comprises:
parsing a compiled version of the computer program to determine a basic block structure;
examining each blocks for instructions that violate predefined purity constraints; and
marking each block as pure, not pure, or pure given called functions are pure, based on the examination of each block.

17. A computer system comprising:
a pure function identifier configured to parse a computer program to identify a plurality of pure functions, the computer program to be executed on the computer system;
a storage device coupled to the pure function identifier, the storage device configured to store a computed result of one of the pure functions to be shared with at least one process of the computer program; and
a pure function modifier coupled to the storage device, the pure function modifier configured to replace an invocation at least one pure function with the computed result of the corresponding pure function.

18. The computer system of claim 17 wherein the pure function identifier module comprises:
a pure function rule configured to store a predetermined rule defining which function is a pure function;
a source code parser coupled to the pure function rule module, the source code parser configured to parse the computer program to identify the plurality of pure functions based on the predetermined rule; and
a call chain tracer coupled to the source code parser, the call chain tracer configured to trace a function call chain from functions marked as pure but with possible call-related exceptions to the functions called.

19. The computer system of claim 17 wherein the pure function identifier comprises:
a compiled code block identifier configured to identify blocks of code of a compiled version of the computer program that correspond to pure functions; and
a pure function code block parser coupled to the compiled code block identifier, the pure function code block parser configured to parse for the identified blocks in the compiled version of the computer program.

20. The computer system of claim 17 wherein the pure function identifier comprises:
a basic block structure parser configured to parse a compiled version of the computer program to determine a basic block structure;
a block analyzer coupled to the basic block structure parser module, the block analyzer configured to examine each blocks for instructions that violate predefined purity constraints; and
a block marker coupled to the block analyzer module, the block marker configured to mark each block as pure, not pure, or pure given called functions are pure, based on the examination of each block.
